(19) United States
(12) Patent Application Publication
(10) Pub. No.: US 2025/0008392 A1
(43) Pub. Date: Jan. 2, 2025

(54) RECOVERY MECHANISM FOR SINGLE ACTIVE PROTOCOL STACK HANDOVER

(71) Applicant: Nokia Technologies Oy, Espoo (FI)

(72) Inventors: Ahmad AWADA, Munich (DE); Ingo VIERING, Munich (DE); Jedrzej Stanczak STANCZAK, Wroclaw (PL)

(21) Appl. No.: 18/705,459

(22) PCT Filed: Sep. 30, 2022
(86) PCT No.: PCT/EP2022/077276

§ 371 Date: Apr. 26, 2024

Related U.S. Application Data
(60) Provisional application No. 63/263,130, filed on Oct. 27, 2021.

(51) Int. Cl. H04W 36/00; H04W 36/08

(52) U.S. Cl. CPC H04W 36/0079; H04W 36/0077; H04W 36/08

(57) ABSTRACT

Systems, methods, apparatuses, and computer program products for a recovery mechanism for single active protocol stack handover. A method may include performing a random access procedure with a target base station. The method may also include receiving, during the random access procedure, a random access response from the target base station. A timer may be started for a predefined duration upon receiving the random access response. The method may further include, when a random access complete message is not sent to a source base station, or a radio resource control connection reconfiguration message is not received from the source base station within the predefined duration, informing the target base station about the failure to send the random access complete message to the source base station, or the failure to receive the radio resource control connection reconfiguration message from the source base station. Handover may be completed to the target base station upon expiration of the timer.

### FIELD

Some example embodiments may generally relate to mobile or wireless telecommunication systems, such as Long Term Evolution (LTE) or fifth generation (5G) new radio (NR) access technology, or other communications systems. For example, certain example embodiments may relate to apparatuses, systems, and/or methods for a recovery mechanism for single active protocol stack handover.

### BACKGROUND

Examples of mobile or wireless telecommunication systems may include the Universal Mobile Telecommunications System (UMTS) Terrestrial Radio Access Network (UTRAN), Long Term Evolution (LTE) Evolved UTRAN (E-UTRAN), LTE-Advanced (LTE-A), MulteFire, LTE-A Pro, and/or fifth generation (5G) radio access technology or new radio (NR) access technology. Fifth generation (5G) wireless systems refer to the next generation (NG) of radio systems and network architecture. 5G network technology is mostly based on new radio (NR) technology, but the 5G (or NG) network can also build on E-UTRAN radio. It is estimated that NR will provide bitrates on the order of 10-20 Gbit/s or higher, and will support at least enhanced mobile broadband (eMBB) and ultra-reliable low-latency communication (URLLC) as well as massive machine-type communication (mMTC). NR is expected to deliver extreme broadband and ultra-robust, low-latency connectivity and massive networking to support the Internet of Things (IoT).

### SUMMARY

Some example embodiments may be directed to a method. The method may include performing a random access procedure with a target base station. The method may further include receiving, during the random access procedure, a random access response from the target base station. The method may further include starting a timer for a predefined duration upon receiving the random access response. The method may further include, when a random access complete message is not sent to a source base station, or a radio resource control connection reconfiguration message is not received from the source base station within the predefined duration, informing the target base station about the failure to send the random access complete message to the source base station, or the failure to receive the radio resource control connection reconfiguration message from the source base station. The method may further include completing handover to the target base station upon expiration of the timer.

Other example embodiments may be directed to an apparatus. The apparatus may include at least one processor and at least one memory including computer program code. The at least one memory and computer program code may also be configured to, with the at least one processor, cause the apparatus at least to perform a random access procedure with a target base station. The at least one memory and computer program code may also be further configured to, with the at least one processor, cause the apparatus at least to receive, during the random access procedure, a random access response from the target base station. The at least one memory and computer program code may also be further configured to, with the at least one processor, cause the apparatus at least to start a timer for a predefined duration upon receiving the random access response. The at least one memory and computer program code may also be further configured to, with the at least one processor, cause the apparatus at least to, when a random access complete message is not sent to a source base station, or a radio resource control connection reconfiguration message is not received from the source base station within the predefined duration, inform the target base station about the failure to send the random access complete message to the source base station, or the failure to receive the radio resource control connection reconfiguration message from the source base station. The at least one memory and computer program code may also be further configured to, with the at least one processor, cause the apparatus at least to complete handover to the target base station upon expiration of the timer.

Other example embodiments may be directed to an apparatus. The apparatus may include means for performing a random access procedure with a target base station. The apparatus may further include means for receiving, during the random access procedure, a random access response from the target base station. The apparatus may further include means for starting a timer for a predefined duration upon receiving the random access response. The apparatus may further include means for, when a random access complete message is not sent to a source base station, or a radio resource control connection reconfiguration message is not received from the source base station within the predefined duration, informing the target base station about the failure to send the random access complete message to the source base station, or the failure to receive the radio resource control connection reconfiguration message from the source base station. The apparatus may further include means for completing handover to the target base station upon expiration of the timer.

In accordance with other example embodiments, a non-transitory computer readable medium may be encoded with instructions that may, when executed in hardware, perform a method. The method may include performing a random access procedure with a target base station. The method may further include receiving, during the random access procedure, a random access response from the target base station. The method may further include starting a timer for a predefined duration upon receiving the random access response. The method may further include, when a random access complete message is not sent to a source base station, or a radio resource control connection reconfiguration message is not received from the source base station within the predefined duration, informing the target base station about the failure to send the random access complete message to the source base station, or the failure to receive the radio resource control connection reconfiguration message from the source base station. The method may further include completing handover to the target base station upon expiration of the timer.

Other example embodiments may be directed to a computer program product that performs a method. The method may include performing a random access procedure with a target base station. The method may further include receiving, during the random access procedure, a random access response from the target base station. The method may further include starting a timer for a predefined duration upon receiving the random access response. The method may further include, when a random access complete message is not sent to a source base station, or a radio resource control connection reconfiguration message is not received from the source base station within the predefined duration, informing the target base station about the failure to send the random access complete message to the source base station, or the failure to receive the radio resource control connection reconfiguration message from the source base station. The method may further include completing handover to the target base station upon expiration of the timer.

Other example embodiments may be directed to an apparatus that may include circuitry configured to perform a random access procedure with a target base station. The apparatus may further include circuitry configured to receive, during the random access procedure, a random access response from the target base station. The apparatus may further include circuitry configured to start a timer for a predefined duration upon receiving the random access response. The apparatus may further include circuitry configured to, when a random access complete message is not sent to a source base station, or a radio resource control connection reconfiguration message is not received from the source base station within the predefined duration, inform the target base station about the failure to send the random access complete message to the source base station, or the failure to receive the radio resource control connection reconfiguration message from the source base station. The apparatus may further include circuitry configured to complete handover to the target base station upon expiration of the timer.

Certain example embodiments may be directed to a method. The method may include performing a random access procedure with a user equipment. The method may further include sending, during the random access procedure, a random access response to the user equipment. The method may further include receiving information from the user equipment about a failure to send a random access complete message to a source base station, or a failure to receive a radio resource control connection reconfiguration message from the source base station. The method may further include completing handover of the user equipment upon expiration of a timer in response to the information.

Other example embodiments may be directed to an apparatus. The apparatus may include at least one processor and at least one memory including computer program code. The at least one memory and computer program code may be configured to, with the at least one processor, cause the apparatus at least to perform a random access procedure with a user equipment. The at least one memory and computer program code may also be further configured to, with the at least one processor, cause the apparatus at least to send, during the random access procedure, a random access response to the user equipment. The at least one memory and computer program code may also be further configured to, with the at least one processor, cause the apparatus at least to receive information from the user equipment about a failure to send a random access complete message to a source base station, or a failure to receive a radio resource control connection reconfiguration message from the source base station. The at least one memory and computer program code may also be further configured to, with the at least one processor, cause the apparatus at least to complete handover of the user equipment upon expiration of a timer in response to the information.

Other example embodiments may be directed to an apparatus. The apparatus may include means for performing a random access procedure with a user equipment. The apparatus may further include means for sending, during the random access procedure, a random access response to the user equipment. The apparatus may further include means for receiving information from the user equipment about a failure to send a random access complete message to a source base station, or a failure to receive a radio resource control connection reconfiguration message from the source base station. The apparatus may further include means for completing handover of the user equipment upon expiration of a timer in response to the information.

In accordance with other example embodiments, a non-transitory computer readable medium may be encoded with instructions that may, when executed in hardware, perform a method. The method may include performing a random access procedure with a user equipment. The method may further include sending, during the random access procedure, a random access response to the user equipment. The method may further include receiving information from the user equipment about a failure to send a random access complete message to a source base station, or a failure to receive a radio resource control connection reconfiguration message from the source base station. The method may further include completing handover of the user equipment upon expiration of a timer in response to the information.

Other example embodiments may be directed to a computer program product that performs a method. The method may include performing a random access procedure with a user equipment. The method may further include sending, during the random access procedure, a random access response to the user equipment. The method may further include receiving information from the user equipment about a failure to send a random access complete message to a source base station, or a failure to receive a radio resource control connection reconfiguration message from the source base station. The method may further include completing handover of the user equipment upon expiration of a timer in response to the information.

Other example embodiments may be directed to an apparatus that may include circuitry configured to perform a random access procedure with a user equipment. The apparatus may further include circuitry configured to send, during the random access procedure, a random access response to the user equipment. The apparatus may further include circuitry configured to receive information from the user equipment about a failure to send a random access complete message to a source base station, or a failure to receive a radio resource control connection reconfiguration message from the source base station. The apparatus may further include circuitry configured to complete handover of the user equipment upon expiration of a timer in response to the information.

### BRIEF DESCRIPTION OF THE DRAWINGS

For proper understanding of example embodiments, reference should be made to the accompanying drawings, wherein:

FIG. 1 illustrates an example signal diagram for a single active protocol stack (SAPS) handover.

FIG. 2 illustrates an example signal diagram of a fallback mechanism for SAPS handover, according to certain example embodiments.

FIG. 3 illustrates an example flow diagram of a method, according to certain example embodiments.

FIG. 4 illustrates an example flow diagram of another method, according to certain example embodiments.

FIG. 5(a) illustrates an apparatus, according to certain example embodiments.

FIG. 5(b) illustrates another apparatus, according to certain example embodiments.

### DETAILED DESCRIPTION

It will be readily understood that the components of certain example embodiments, as generally described and illustrated in the figures herein, may be arranged and designed in a wide variety of different configurations. The following is a detailed description of some example embodiments of systems, methods, apparatuses, and computer program products for a recovery mechanism for single active protocol stack (SAPS) handover.

The features, structures, or characteristics of example embodiments described throughout this specification may be combined in any suitable manner in one or more example embodiments. For example, the usage of the phrases “certain embodiments,” “an example embodiment,” “some embodiments,” or other similar language, throughout this specification refers to the fact that a particular feature, structure, or characteristic described in connection with an embodiment may be included in at least one embodiment. Thus, appearances of the phrases “in certain embodiments,” “an example embodiment,” “in some embodiments,” “in other embodiments,” or other similar language, throughout this specification do not necessarily refer to the same group of embodiments, and the described features, structures, or characteristics may be combined in any suitable manner in one or more example embodiments. Further, the terms “base station”, “node”, “gNB”, or other similar language throughout this specification may be used interchangeably.

Support of various Industrial Internet of Things/URLLC (IIoT/URLLC) use cases have been areas of interest in 3^{rd} Generation Partnership Project (3GPP) since the release of the 5G design. For certain 5G applications such as, for example, ones that are not supported by traditional telecommunication operators, there may be many new IIoT/URLLC applications/services from different vertical domains such as factory automation, audio/video production, etc. URLLC and TSC communications have been envisioned as key enablers to support existing applications and new emerging applications.

In 3GPP, dual active protocol stack (DAPS) handover has been specified for FR1-FR1, FR1-FR2, and FR2-FR1, but not for FR2-FR2. Moreover, the DAPS solution may be more complex than a baseline handover since a user equipment (UE) needs to maintain two L2 protocol stacks (e.g., physical/medium access control/radio link control (PHY/MAC/RLC)), and communicate with both a packet data convergence protocol (PDCP) layer of a source and target base station using different security keys and header compression algorithms. On the other hand, single active protocol stack (SAPS) has been identified as an alternative for DAPS, which can achieve similar performance gains of DAPS, while with much lower complexity since the UE communicates with only one PDCP at a time. However, SAPS has not been adopted in 3GPP Release 16 since it cannot achieve exactly 0 ms. Furthermore, DAPS may cause significant complexity to the terminal. As such, SAPS may serve as a potential candidate solution to reduce the interruption time during handover for cases where absolute 0 ms interruption is not required.

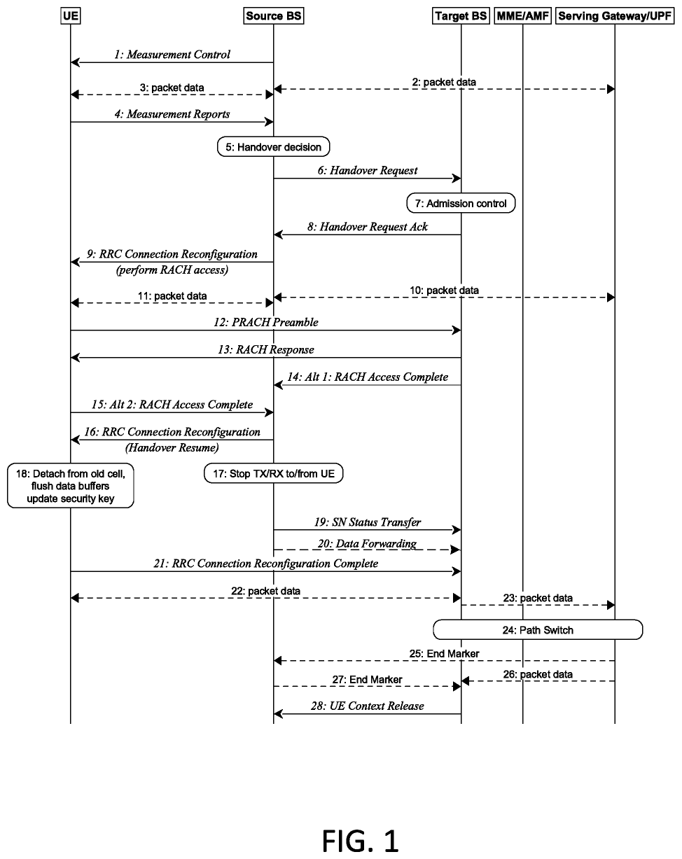

FIG. 1 illustrates an example signal diagram for SAPS handover. In particular, at operation 1, the source base station (BS) may configure the UE to perform measurements. At operations 2 and 3, packet data may be exchanged between the UE and source BS, and between the source BS and a serving gateway/user plane function (UPF). At operation 4, the UE may send a measurement report(s) to the source BS according to the measurement configuration. At operation 5, the source BS may decide to handover the UE based on the measurement report and radio resource management (RRM) information. At operation 6, the source BS may issue a handover request message to the target BS, passing the necessary information to prepare the handover at the target side. At operation 7, admission control may be performed by the target BS. At operation 8, the target BS may prepare the handover, and send a handover request acknowledgment (ACK) to the source BS, which may include a transparent container to be sent to the UE as an RRC message to perform the handover. At operation 9, the source BS may trigger the Uu handover by sending an RRC Connection Reconfiguration message to the UE. At operations 10 and 11, after receiving the RCC Connection Reconfiguration message at operation 9 (which may include a command to perform SAPS handover), the source BS (i.e., source base station) and the UE may continue to exchange user plane packets in DL and UL, and the source BS and the serving gateway/UPF may also continue to exchange user plane packets in DL and UL.

As further illustrated in FIG. 1, at operations 12 and 13, the UE may perform a random access procedure with the target BS (i.e., target base station). When this is completed, the source BS may be informed either by the target BS (alternative 1 in operation 14), or by the UE via an appropriate message (alternative 2 in operation 15) about the completion of the random access procedure. At this point, most of the time-critical handover related procedures have been exchanged, but no user data interruption has occurred since the UE is exchanging user data with the source BS.

As also illustrated in FIG. 1, at operation 16, the source base station may send a Handover Resume message (using a radio resource control (RRC) message or lower layer medium access control element (MAC CE)) to the UE, may stop DL transmission, and may start data forwarding to the target base station. Additionally, at operation 17, the source BS may stop DL transmission, and at operation 20, may start data forwarding to the target BS.

After receiving the Handover Resume message at operation 16, the UE may, at operation 18, detach from the source BS, flush its buffers, and update the security key. Flushing of the buffers may simplify the procedure against DAPS handover since the UE may switch at this time to apply the PDCP configuration of the target BS. Once the UE is detached from the source BS, at operation 19, the source BS may perform a sequence number (SN) status transfer to the target BS. Further, at operation 21, the UE may send the RRC Connection Reconfiguration Complete message to the target BS. Additionally, at operations 22 and 23, the UE and the target BS may exchange user plane packets in DL and UL, and the target BS and serving gateway/UPF may also exchange user plane packets in DL and UL.

Furthermore, at operation 24, the serving gateway/UPF may switch the DL data path towards the target BS and, at operation 25, the serving gateway/UPF may send one or more “end marker” packets on the old path to the source BS. Additionally, at operation 26, the serving gateway/UPF may send user plane packets in DL and UL to the target BS. Further, at operation 27, the source BS may send an end marker packet to the target BS. At operation 28, the target BS may send a UE Context Release message to the source BS, which informs the source BS of the success of handover, and triggers the release of resources by the source BS.

In some cases, in the SPAS handover illustrated in FIG. 1, the UE may receive the RRC Reconfiguration including the command to perform SAPS handover in operation 9. The UE may also successfully perform random access in operations 12 and 13, but fails to either send the “RACH Access Complete” message in operation 15 (if alternative 2 is adopted), or receive the Handover Resume message in operation 16. In this case, the UE would most likely end up detecting a radio link failure (RLF), and perform re-establishment although it has already successfully performed the random access to the target (retrieving a valid timing advance), and has the configuration of the target base station.

3GPP describes condition handover (CHO) recovery in an effort to enable fast recovery of the link. However, there are certain drawbacks of the CHO recovery. For instance, the UE may need to wait for the RLF to occur before triggering CHO recovery. This may cause interruption time for the UE (which is likely unnecessary since RACH has already been successful). Additionally, the network may need to prepare and configure the UE with a conditional reconfiguration in addition to the configuration that is needed to perform SAPS handover. As such, this may increase signaling overhead and resource reservation. Furthermore, in CHO recovery, the UE may need to perform random access (as it is part of the CHO and any handover in general). Thus, certain example embodiments may provide an alternate recovery mechanism for SAPS handover that does not have the aforementioned drawbacks.

Certain example embodiments may provide a recovery method for SAPS handover where the UE completes the handover and sends the RRC Reconfiguration Complete message to the target base station if it did not receive the Handover Resume message from the source base station within a predefined time duration after receiving the RA Response (RAR). As the target base station is not able to distinguish in this case a normal SAPS execution from SAPS recovery, the UE may indicate to the target base station the failure to receive the Handover Resume command (operation 16 in FIG. 1) such that the target base station can obtain the user data from the source base station by sending, for instance, a “Handover Success” message which was defined for CHO.

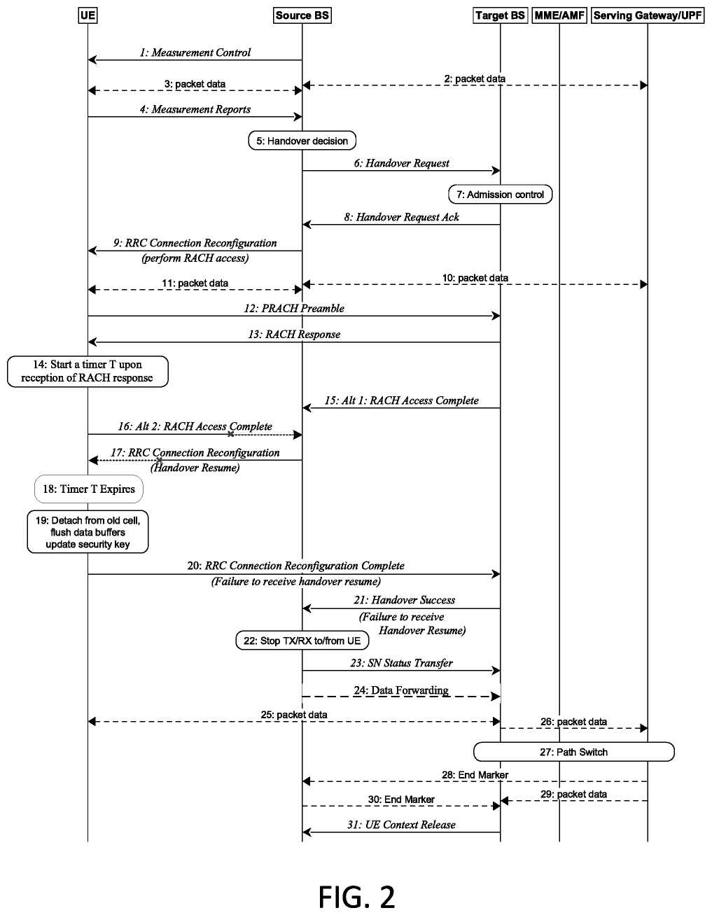

FIG. 2 illustrates an example signal diagram of a fallback mechanism for SAPS handover, according to certain example embodiments. Certain operations illustrated in FIG. 2 may be similar to some of the operations illustrated in FIG. 1 described above. Thus, the description of overlapping operations will not be repeated herein. According to certain example embodiments, the fallback mechanism for SAPS handover illustrated in FIG. 2 may correspond to a case when the UE fails to either send a “RACH Access Complete” message in operation 16 (if alternative 2 is adopted), or fails to receive the Handover Resume message in operation 17.

As illustrated in FIG. 2, at operation 14, the UE may start a timer T upon the reception of the RAR from the target base station. That is, the UE may start the timer T upon receiving the RACH response from the target base station that is controlled by a target base station (BS). According to certain example embodiments, the timer T may be configured by the source base station or by the target base station, and may be received by the RRC Reconfiguration containing the (SAPS) handover command. According to further example embodiments, the timer T may be stopped when the UE receives the Handover Resume message from the source base station (operation 17).

At operation 16, the UE may fail to send the RACH Access Complete message to the source base station (if alternative 2 is adopted), or to receive in operation 17, the RRC Connection Reconfiguration (Handover Resume) message from the source base station.

In certain example embodiments, if the timer T expires (operation 18), the UE may detach from the old/source base station, flush the data buffers of, for example, MAC/RLC/PDCP, and update the security key of PDCP (operation 19). Furthermore, the UE may send an RRC Reconfiguration Complete message (operation 20) to the target base station indicating the completion of the HO.

In other example embodiments, if the timer T expires, the UE may inform the target base station (operation 20) about the failure to receive the Handover Resume message (at operation 17) from the source base station. For instance, in some example embodiments, the failure may be indicated by the UE by including an indication X in the RRC Reconfiguration Complete message. However, in other example embodiments, the UE may include the indication X in a MAC CE that can be multiplexed with the MAC service data unit (SDU) containing the RRC Reconfiguration Complete message.

According to certain example embodiments, upon receiving the indication about the failure to receive the Handover Resume from the source base station, the target base station may send a Handover Success message (operation 21) to the source base station. In other words, since the source base station is not aware that the UE has detached, the target base station may inform the source base station (operation 21) about the successful completion of the handover without the reception of the RRC Connection Reconfiguration (Handover Resume) message from the source base station. In response to receiving the Handover Success message, the source base station may initiate data forwarding to the target base station (operation 24). Upon receiving the Handover Success message from the target base station, the source base station may stop the DL transmission (operation 22), and send the sequence number (SN) status transfer message (operation 23) and forward the user plane data to the target node (operation 24).

In certain example embodiments, the Handover Success message (operation 21) may include an indication to the source base station that the handover is a SAPS handover (and not a CHO handover), and that the UE has failed to receive the Handover Resume message from the source base station (operation 17). Similar to the CHO, the source base station may start packet forwarding (operation 24) after receiving the Handover Success message. At operation 25, user plane communication of packet data may occur between the UE and the target base station. Additionally, at operation 26, the target base station may transmit the packet data to the serving gateway/UPF.

According to certain example embodiments, the UE may send the RRC Reconfiguration Complete/indication X using a periodic UL grant (instead of a single UL grant) that is indicated in the RACH Response received from the target base station. According to certain example embodiments, the UL grant may be periodic since the target base station is not aware when the source base station sends the Handover Resume message to the UE, or when the UE performs the SAPS recovery. According to other example embodiments, the periodic UL grant may be sent in the RRC Reconfiguration message, and sending the periodic UL grant may include the handover command (as in LTE RACH-less HO mechanism). Furthermore, sending the periodic UL grant in this manner may lead to a waste of UL resources as they may be needed by the UE when it successfully receives the RACH Response which can take a certain amount of time (e.g., ˜up to the duration of T304 timer controlling the random access procedure to the target base station). As an example, the target base station may provide the value of the T304 time to the UE. With respect to FIG. 1, the value may be provided by the target BS in a Handover Request ACK (step 8) as part of the handover command; the source BS (using the radio link of the source base station) may then provide it to the UE using RRC Reconfiguration containing the handover command received from the target BS. The value of T304 may specified, such as t304 ENUMERATED {ms50, ms100, ms150, ms200, ms500, ms1000, ms2000, ms10000}. Additionally or alternatively, t304 may be set to any value, such as 50 ms, 10 ms, up to 10 s.

In certain example embodiments, the UE may acknowledge, by lower layer signaling (e.g., on physical uplink control channel (PUCCH)), the successful reception of the RACH response to the target base station (before starting timer T). According to certain example embodiments, the acknowledgment may be needed in case the target base station needs to send a RACH Access Complete message to the source base station (operation 15). Otherwise, the target base station cannot be sure that the UE has received the RAR.

In other example embodiments, the UE may acknowledge the successful reception of the RACH response to the source base station (before starting timer T) if the UE has performed contention-based random access (CBRA) to the target base station. According to certain example embodiments, this type of acknowledgment may be needed in case the target base station cannot identify the UE when CBRA is performed. As such, the target base station would not be able to indicate the success of RACH access to the source base station. Instead, the UE may indicate the successful reception of the RACH to the source base station (alternative 2 in operation 16 of FIG. 2) in case of CBRA, and in case of contention-free random access (CFRA), the target base station may indicate the successful reception to the source base station (operation 15, FIG. 2) (mixed approach of Alt-1 and Alt-2).

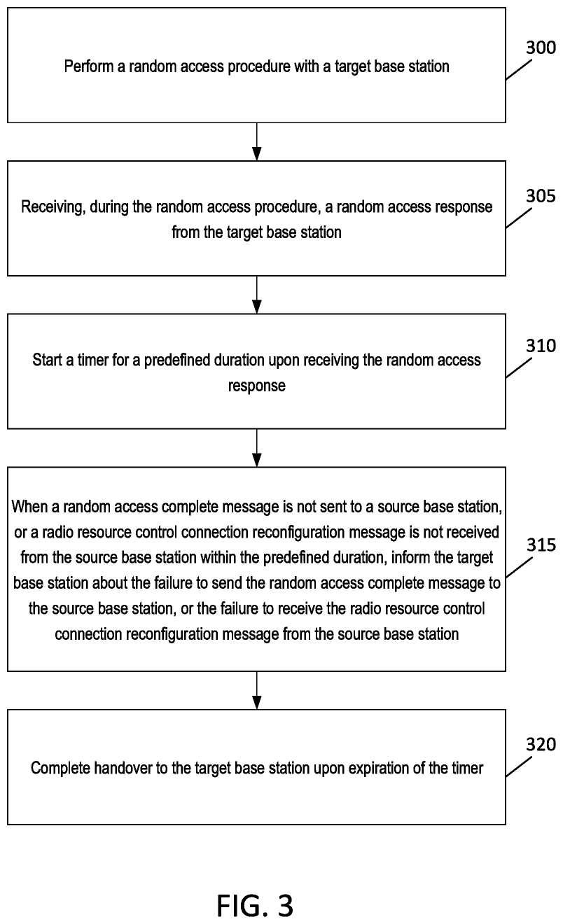

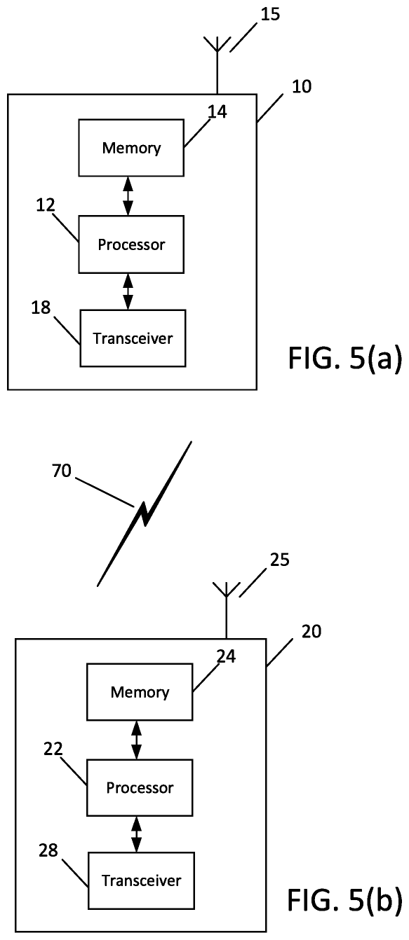

FIG. 3 illustrates an example flow diagram of a method, according to certain example embodiments. In an example embodiment, the method of FIG. 3 may be performed by a network entity, or a group of multiple network elements in a 3GPP system, such as LTE or 5G-NR. For instance, in an example embodiment, the method of FIG. 3 may be performed by a UE similar to one of apparatuses 10 or 20 illustrated in FIGS. 5(a) and 5(b).

According to certain example embodiments, the method of FIG. 3 may include, at 300, performing a random access procedure with a target base station. At 305, the method may include receiving, during the random access procedure, a random access response from the target base station. Further, at 310, the method may include starting a timer for a predefined duration upon receiving the random access response. In addition, at 315, the method may include when a random access complete message is not sent to a source base station, or a radio resource control connection reconfiguration message is not received from the source base station within the predefined duration, informing the target base station about the failure to send the random access complete message to the source base station, or the failure to receive the radio resource control connection reconfiguration message from the source base station. At 320, the method may also completing handover to the target base station upon expiration of the timer.

According to certain example embodiments, after the timer expires, the method may further include detaching from the source base station, flushing data buffers, and updating a security key. According to some example embodiments, the method may also include stopping the timer when the radio resource control connection reconfiguration message is received from the source base station. According to other example embodiments, informing the target base station is performed by sending a radio resource control connection reconfiguration complete message comprising an indication, or multiplexing an indication in a medium access control element with a medium access service data unit. In certain example embodiments, the radio resource control connection reconfiguration complete message or the indication may be sent using a periodic uplink grant received from the target base station. In some other embodiment, the periodic uplink grant is indicated in the random access response that is received from the target base station. In some example embodiments, the method may further include acknowledging, by lower layer signaling, successful reception of the random access response to the target base station before starting the timer. In other example embodiments, the method may include acknowledging, by lower layer signaling, successful reception of the random access response to the source base station before starting the timer.

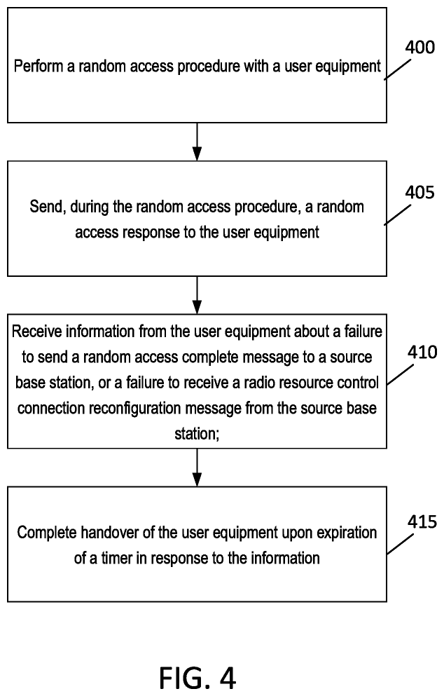

FIG. 4 illustrates an example flow diagram of another method, according to certain example embodiments. In an example embodiment, the method of FIG. 4 may be performed by a network entity, or a group of multiple network elements in a 3GPP system, such as LTE or 5G-NR. For instance, in an example embodiment, the method of FIG. 4 may be performed by a gNB, BS, or other similar network element such as one of apparatuses 10 or 20 illustrated in FIGS. 5(a) and 5(b).

According to certain example embodiments, the method of FIG. 4 may include, at 400, performing a random access procedure with a user. At 405, the method may include sending, during the random access procedure, a random access response to the user equipment. Further, at 410, the method may include receiving information from the user equipment about a failure to send a random access complete message to a source base station, or a failure to receive a radio resource control connection reconfiguration message from the source base station. In addition, at 415, the method may include completing handover of the user equipment upon expiration of a timer in response to the information.

According to certain example embodiments, the method may also include informing the source base station about successful completion of the handover without the reception of the radio resource control connection reconfiguration message from the source base station. According to some example embodiments, the method may further include receiving user plane data from the source base station after informing the source base station about successful completion of the handover. According to other example embodiments, the information is received from the user equipment via a radio resource control connection reconfiguration complete message comprising an indication, or an indication multiplexed in a medium access control element with a medium access service data unit. In certain example embodiments, the radio resource control connection reconfiguration complete message or the indication may be received via a periodic uplink grant. In some other embodiment, the periodic uplink grant is indicated in the random access response that is sent to the UE. In some example embodiments, the method may also include receiving an acknowledgment from the user equipment via lower layer signaling of successful reception of the random access response before the timer is started.

FIG. 5(a) illustrates an apparatus 10 according to certain example embodiments. In certain example embodiments, the apparatus 10 may be a node or element in a communications network or associated with such a network, such as a UE, mobile equipment (ME), mobile station, mobile device, stationary device, IoT device, or other device. It should be noted that one of ordinary skill in the art would understand that apparatus 10 may include components or features not shown in FIG. 5(a).

In some example embodiments, apparatus 10 may include one or more processors, one or more computer-readable storage medium (for example, memory, storage, or the like), one or more radio access components (for example, a modem, a transceiver, or the like), and/or a user interface. In some example embodiments, apparatus 10 may be configured to operate using one or more radio access technologies, such as GSM, LTE, LTE-A, NR, 5G, WLAN, WiFi, NB-IoT, Bluetooth, NFC, MulteFire, and/or any other radio access technologies. It should be noted that one of ordinary skill in the art would understand that apparatus 10 may include components or features not shown in FIG. 5(a).

As illustrated in the example of FIG. 5(a), apparatus 10 may include or be coupled to a processor 12 for processing information and executing instructions or operations. Processor 12 may be any type of general or specific purpose processor. In fact, processor 12 may include one or more of general-purpose computers, special purpose computers, microprocessors, digital signal processors (DSPs), field-programmable gate arrays (FPGAs), application-specific integrated circuits (ASICs), and processors based on a multi-core processor architecture, as examples. While a single processor 12 is shown in FIG. 5(a), multiple processors may be utilized according to other example embodiments. For example, it should be understood that, in certain example embodiments, apparatus 10 may include two or more processors that may form a multiprocessor system (e.g., in this case processor 12 may represent a multiprocessor) that may support multiprocessing. According to certain example embodiments, the multiprocessor system may be tightly coupled or loosely coupled (e.g., to form a computer cluster).

Processor 12 may perform functions associated with the operation of apparatus 10 including, as some examples, precoding of antenna gain/phase parameters, encoding and decoding of individual bits forming a communication message, formatting of information, and overall control of the apparatus 10, including processes illustrated in FIGS. 1-3.

Apparatus 10 may further include or be coupled to a memory 14 (internal or external), which may be coupled to processor 12, for storing information and instructions that may be executed by processor 12. Memory 14 may be one or more memories and of any type suitable to the local application environment, and may be implemented using any suitable volatile or nonvolatile data storage technology such as a semiconductor-based memory device, a magnetic memory device and system, an optical memory device and system, fixed memory, and/or removable memory. For example, memory 14 can be comprised of any combination of random access memory (RAM), read only memory (ROM), static storage such as a magnetic or optical disk, hard disk drive (HDD), or any other type of non-transitory machine or computer readable media. The instructions stored in memory 14 may include program instructions or computer program code that, when executed by processor 12, enable the apparatus 10 to perform tasks as described herein.

In certain example embodiments, apparatus 10 may further include or be coupled to (internal or external) a drive or port that is configured to accept and read an external computer readable storage medium, such as an optical disc, USB drive, flash drive, or any other storage medium. For example, the external computer readable storage medium may store a computer program or software for execution by processor 12 and/or apparatus 10 to perform any of the methods illustrated in FIGS. 1-3.

In some example embodiments, apparatus 10 may also include or be coupled to one or more antennas 15 for receiving a downlink signal and for transmitting via an uplink from apparatus 10. Apparatus 10 may further include a transceiver 18 configured to transmit and receive information. The transceiver 18 may also include a radio interface (e.g., a modem) coupled to the antenna 15. The radio interface may correspond to a plurality of radio access technologies including one or more of GSM, LTE, LTE-A, 5G, NR, WLAN, NB-IoT, Bluetooth, BT-LE, NFC, RFID, UWB, and the like. The radio interface may include other components, such as filters, converters (for example, digital-to-analog converters and the like), symbol demappers, signal shaping components, an Inverse Fast Fourier Transform (IFFT) module, and the like, to process symbols, such as OFDMA symbols, carried by a downlink or an uplink.

For instance, transceiver 18 may be configured to modulate information on to a carrier waveform for transmission by the antenna(s) 15 and demodulate information received via the antenna(s) 15 for further processing by other elements of apparatus 10. In other example embodiments, transceiver 18 may be capable of transmitting and receiving signals or data directly. Additionally or alternatively, in some example embodiments, apparatus 10 may include an input and/or output device (I/O device). In certain example embodiments, apparatus 10 may further include a user interface, such as a graphical user interface or touchscreen.

In certain example embodiments, memory 14 stores software modules that provide functionality when executed by processor 12. The modules may include, for example, an operating system that provides operating system functionality for apparatus 10. The memory may also store one or more functional modules, such as an application or program, to provide additional functionality for apparatus 10. The components of apparatus 10 may be implemented in hardware, or as any suitable combination of hardware and software. According to certain example embodiments, apparatus 10 may optionally be configured to communicate with apparatus 20 via a wireless or wired communications link 70 according to any radio access technology, such as NR.

According to certain example embodiments, processor 12 and memory 14 may be included in or may form a part of processing circuitry or control circuitry. In addition, in some example embodiments, transceiver 18 may be included in or may form a part of transceiving circuitry.

For instance, in certain example embodiments, apparatus 10 may be controlled by memory 14 and processor 12 to perform a random access procedure with a target base station. Apparatus 10 may also be controlled by memory 14 and processor 12 to receive, during the random access procedure, a random access response from the target base station. Apparatus 10 may further be controlled by memory 14 and processor 12 to start a timer for a predefined duration upon receiving the random access response. In addition, apparatus 10 may be controlled by memory 14 and processor 12 to, when a random access complete message is not sent to a source base station, or a radio resource control connection reconfiguration message is not received from the source base station within the predefined duration, inform the target base station about the failure to send the random access complete message to the source base station, or the failure to receive the radio resource control connection reconfiguration message from the source base station. Apparatus 10 may also be controlled by memory 14 and processor 12 to complete handover to the target base station upon expiration of the timer.

FIG. 5(b) illustrates an apparatus 20 according to certain example embodiments. In certain example embodiments, the apparatus 20 may be a node or element in a communications network or associated with such a network, such as a base station, a Node B, an evolved Node B (eNB), 5G Node B or access point, next generation Node B (NG-NB or gNB), and/or WLAN access point, associated with a radio access network (RAN), such as an LTE network, 5G or NR. It should be noted that one of ordinary skill in the art would understand that apparatus 20 may include components or features not shown in FIG. 5(b).

As illustrated in the example of FIG. 5(b), apparatus 20 may include a processor 22 for processing information and executing instructions or operations. Processor 22 may be any type of general or specific purpose processor. For example, processor 22 may include one or more of general-purpose computers, special purpose computers, microprocessors, digital signal processors (DSPs), field-programmable gate arrays (FPGAs), application-specific integrated circuits (ASICs), and processors based on a multi-core processor architecture, as examples. While a single processor 22 is shown in FIG. 5(b), multiple processors may be utilized according to other example embodiments. For example, it should be understood that, in certain example embodiments, apparatus 20 may include two or more processors that may form a multiprocessor system (e.g., in this case processor 22 may represent a multiprocessor) that may support multiprocessing. In certain example embodiments, the multiprocessor system may be tightly coupled or loosely coupled (e.g., to form a computer cluster).

According to certain example embodiments, processor 22 may perform functions associated with the operation of apparatus 20, which may include, for example, precoding of antenna gain/phase parameters, encoding and decoding of individual bits forming a communication message, formatting of information, and overall control of the apparatus 20, including processes illustrated in FIGS. 1, 2, and 4.

Apparatus 20 may further include or be coupled to a memory 24 (internal or external), which may be coupled to processor 22, for storing information and instructions that may be executed by processor 22. Memory 24 may be one or more memories and of any type suitable to the local application environment, and may be implemented using any suitable volatile or nonvolatile data storage technology such as a semiconductor-based memory device, a magnetic memory device and system, an optical memory device and system, fixed memory, and/or removable memory. For example, memory 24 can be comprised of any combination of random access memory (RAM), read only memory (ROM), static storage such as a magnetic or optical disk, hard disk drive (HDD), or any other type of non-transitory machine or computer readable media. The instructions stored in memory 24 may include program instructions or computer program code that, when executed by processor 22, enable the apparatus 20 to perform tasks as described herein.

In certain example embodiments, apparatus 20 may further include or be coupled to (internal or external) a drive or port that is configured to accept and read an external computer readable storage medium, such as an optical disc, USB drive, flash drive, or any other storage medium. For example, the external computer readable storage medium may store a computer program or software for execution by processor 22 and/or apparatus 20 to perform the methods illustrated in FIGS. 1, 2, and 4.

In certain example embodiments, apparatus 20 may also include or be coupled to one or more antennas 25 for transmitting and receiving signals and/or data to and from apparatus 20. Apparatus 20 may further include or be coupled to a transceiver 28 configured to transmit and receive information. The transceiver 28 may include, for example, a plurality of radio interfaces that may be coupled to the antenna(s) 25. The radio interfaces may correspond to a plurality of radio access technologies including one or more of GSM, NB-IoT, LTE, 5G, WLAN, Bluetooth, BT-LE, NFC, radio frequency identifier (RFID), ultrawideband (UWB), MulteFire, and the like. The radio interface may include components, such as filters, converters (for example, digital-to-analog converters and the like), mappers, a Fast Fourier Transform (FFT) module, and the like, to generate symbols for a transmission via one or more downlinks and to receive symbols (for example, via an uplink).

As such, transceiver 28 may be configured to modulate information on to a carrier waveform for transmission by the antenna(s) 25 and demodulate information received via the antenna(s) 25 for further processing by other elements of apparatus 20. In other example embodiments, transceiver 18 may be capable of transmitting and receiving signals or data directly. Additionally or alternatively, in some example embodiments, apparatus 20 may include an input and/or output device (I/O device).

In certain example embodiment, memory 24 may store software modules that provide functionality when executed by processor 22. The modules may include, for example, an operating system that provides operating system functionality for apparatus 20. The memory may also store one or more functional modules, such as an application or program, to provide additional functionality for apparatus 20. The components of apparatus 20 may be implemented in hardware, or as any suitable combination of hardware and software.

According to some example embodiments, processor 22 and memory 24 may be included in or may form a part of processing circuitry or control circuitry. In addition, in some example embodiments, transceiver 28 may be included in or may form a part of transceiving circuitry.

As used herein, the term “circuitry” may refer to hardware-only circuitry implementations (e.g., analog and/or digital circuitry), combinations of hardware circuits and software, combinations of analog and/or digital hardware circuits with software/firmware, any portions of hardware processor(s) with software (including digital signal processors) that work together to cause an apparatus (e.g., apparatus 10 and 20) to perform various functions, and/or hardware circuit(s) and/or processor(s), or portions thereof, that use software for operation but where the software may not be present when it is not needed for operation. As a further example, as used herein, the term “circuitry” may also cover an implementation of merely a hardware circuit or processor (or multiple processors), or portion of a hardware circuit or processor, and its accompanying software and/or firmware. The term circuitry may also cover, for example, a baseband integrated circuit in a server, cellular network node or device, or other computing or network device.

For instance, in certain example embodiments, apparatus 20 may be controlled by memory 24 and processor 22 to perform a random access procedure with a user equipment. Apparatus 20 may also be controlled by memory 24 and processor 22 to send, during the random access procedure, a random access response to the user equipment. Apparatus 20 may further be controlled by memory 24 and processor 22 to receive information from the user equipment about a failure to send a random access complete message to a source base station, or a failure to receive a radio resource control connection reconfiguration message from the source base station. In addition, apparatus 20 may be controlled by memory 24 and processor 22 to complete handover of the user equipment upon expiration of a timer in response to the information.

In some example embodiments, an apparatus (e.g., apparatus 10 and/or apparatus 20) may include means for performing a method, a process, or any of the variants discussed herein. Examples of the means may include one or more processors, memory, controllers, transmitters, receivers, and/or computer program code for causing the performance of the operations.

Certain example embodiments may be directed to an apparatus that includes means for performing any of the methods described herein including, for example, means for performing a random access procedure with a target base station. The apparatus may also include means for receiving, during the random access procedure, a random access response from the target base station. The apparatus may further include means for starting a timer for a predefined duration upon receiving the random access response. In addition, the apparatus may include means for, when a random access complete message is not sent to a source base station, or a radio resource control connection reconfiguration message is not received from the source base station within the predefined duration, informing the target base station about the failure to send the random access complete message to the source base station, or the failure to receive the radio resource control connection reconfiguration message from the source base station. The apparatus may also include means for completing handover to the target base station upon expiration of the timer.

Certain example embodiments may also be directed to an apparatus that includes means for performing a random access procedure with a user equipment. The apparatus may also include means for sending, during the random access procedure, a random access response to the user equipment. The apparatus may further include means for receiving information from the user equipment about a failure to send a random access complete message to a source base station, or a failure to receive a radio resource control connection reconfiguration message from the source base station. Further, the apparatus may include means for completing handover of the user equipment upon expiration of a timer in response to the information.

Certain example embodiments described herein provide several technical improvements, enhancements, and/or advantages. In some example embodiments, it may be possible to avoid the interruption time and signaling overhead associated with the re-establishment procedure. It may also be possible to provide a fast and slim recovery procedure. Furthermore, it may be possible to maintain continued access to the target base station despite any radio issues that may be present on the source base station link.

A computer program product may include one or more computer-executable components which, when the program is run, are configured to carry out some example embodiments. The one or more computer-executable components may be at least one software code or portions of it. Modifications and configurations required for implementing functionality of certain example embodiments may be performed as routine(s), which may be implemented as added or updated software routine(s). Software routine(s) may be downloaded into the apparatus.

As an example, software or a computer program code or portions of it may be in a source code form, object code form, or in some intermediate form, and it may be stored in some sort of carrier, distribution medium, or computer readable medium, which may be any entity or device capable of carrying the program. Such carriers may include a record medium, computer memory, read-only memory, photoelectrical and/or electrical carrier signal, telecommunications signal, and software distribution package, for example. Depending on the processing power needed, the computer program may be executed in a single electronic digital computer or it may be distributed amongst a number of computers. The computer readable medium or computer readable storage medium may be a non-transitory medium.

In other example embodiments, the functionality may be performed by hardware or circuitry included in an apparatus (e.g., apparatus 10 or apparatus 20), for example through the use of an application specific integrated circuit (ASIC), a programmable gate array (PGA), a field programmable gate array (FPGA), or any other combination of hardware and software. In yet another example embodiment, the functionality may be implemented as a signal, a non-tangible means that can be carried by an electromagnetic signal downloaded from the Internet or other network.

According to certain example embodiments, an apparatus, such as a node, device, or a corresponding component, may be configured as circuitry, a computer or a microprocessor, such as single-chip computer element, or as a chipset, including at least a memory for providing storage capacity used for arithmetic operation and an operation processor for executing the arithmetic operation.

One having ordinary skill in the art will readily understand that the invention as discussed above may be practiced with procedures in a different order, and/or with hardware elements in configurations which are different than those which are disclosed. Therefore, although the invention has been described based upon these example embodiments, it would be apparent to those of skill in the art that certain modifications, variations, and alternative constructions would be apparent, while remaining within the spirit and scope of example embodiments. Although the above embodiments refer to 5G NR and LTE technology, the above embodiments may also apply to any other present or future 3GPP technology, such as LTE-advanced, and/or fourth generation (4G) technology.

### Partial Glossary

3GPP 3rd Generation Partnership Project
5G 5th Generation
5GCN 5G Core Network
5GS 5G System
AMF Access and Mobility Management Function
BS Base Station
CBRA Contention-Based Random Access
CFRA Contention-Free Random Access
CHO Conditional Handover
DAPS Dual Active Protocol Stack
DL Downlink
eNB Enhanced Node B
gNB 5G or Next Generation NodeB
HO Handover
LTE Long Term Evolution
MAC Medium Access Control
MME Mobility Management Entity
NR New Radio
PDCP Packet Data Convergence Protocol
PHY Physical
RAR Random Access Response
RLC Radio Link Control
RLF Radio Link Failure
RRC Radio Resource Control
SAPS Single Active Protocol Stack
TS Technical Specification
UE User Equipment
UL Uplink
UPF User Plane Function

1.-44. (canceled)

45. A system comprising:
a source base station;
a target base station; and
a user equipment comprising:
a first processor; and
a first non-transitory computer-readable medium comprising a first set of computer-executable instructions that, when executed by the first processor, causes the first processor to perform the following operations:
performing a random access procedure with the target base station;
receiving, during the random access procedure, a random access response from the target base station;
sending an acknowledgment, by lower layer signaling on a physical uplink control channel, of a successful reception of the random access response to the target base station; and
based on sending the acknowledgement, starting a timer for a predefined duration upon receiving the random access response, the timer being configured by the target base station; and
based on a radio resource control connection reconfiguration message not being received by the user equipment from the source base station within the predefined duration:
detaching the user equipment from the source base station;
flushing data buffers of medium access control, radio link control, and packet data convergence protocol;
update a security key of the packet data convergence protocol; and
completing handover to the target base station without informing the source base station of a successful handover;
informing the target base station about a failure to receive the radio resource control connection reconfiguration message from the source base station and about a completion of completion of the handover; and
initiate user plane communication of packet data between the user equipment and the target base station;
the source base station comprising:
a second processor; and
a second non-transitory computer-readable medium comprising a second set of computer-executable instructions that, when executed by the second processor, causes the second processor to perform the following operations:
receiving, from the target base station based on the source base station not being aware that the user equipment being detached, and indication of the successful completion of the handover as a result of the user equipment not receiving the radio resource control connection reconfiguration message from the source base station;
receiving, from the target base station, an indication that the handover is a single active protocol stack handover and not a condition handover;
initiate data forwarding to the target base station;
stop downlink transmissions to and from the user equipment;
send a sequence number status transfer message to the target base station; and
forward user plane data to the target base station.

46. The system of claim 45, wherein the first set of computer-executable instructions further cause the first processor to inform the target base station about the completion of the handover by:
sending a radio resource control connection reconfiguration complete message comprising an indication of a failure to receive a handover resume message using a periodic uplink grant received from the target base station.

47. The system of claim 45, wherein the first set of computer-executable instructions further cause the first processor to inform the target base station about the completion of the handover by:
multiplexing an indication of a failure to receive a handover resume message in a medium access control element with a medium access service data unit using a periodic uplink grant received from the target base station.

48. The system of claim 47, wherein the periodic uplink grant is received in the random access response.

49. The system of claim 48, wherein the handover is a single active protocol stack handover and not a condition handover based on the user equipment failing to receive the radio resource control connection reconfiguration message with the predefined duration.

50. The system of claim 49, wherein the second set of computer-executable instructions further cause the second processor to:
send, to the user equipment, the radio resource control connection reconfiguration message.

51. The system of claim 50, wherein the radio resource control connection reconfiguration message is received by the user equipment from the source base station after the predefined duration.

52. A system comprising:
a first apparatus comprising:
a first processor; and
a first non-transitory computer-readable medium comprising a first set of computer-executable instructions that, when executed by the first processor, causes the first processor to perform the following operations:
performing a random access procedure with a target apparatus;
receiving, during the random access procedure, a random access response from the target apparatus;
sending an acknowledgment, by lower layer signaling on a physical uplink control channel, of a successful reception of the random access response to the target apparatus; and
based on sending the acknowledgement, starting a timer for a predefined duration upon receiving the random access response, the timer being configured by the target apparatus; and
based on a radio resource control connection reconfiguration message not being received by the first apparatus from a source apparatus within the predefined duration:
detaching the first apparatus from the source apparatus;
flushing data buffers of medium access control, radio link control, and packet data convergence protocol;
update a security key of the packet data convergence protocol; and
completing handover to the target apparatus without informing the source apparatus of a successful handover;
informing the target apparatus about a failure to receive the radio resource control connection reconfiguration message from the source apparatus and about a completion of completion of the handover; and
initiate user plane communication of packet data between the first apparatus and the target apparatus;
the source apparatus comprising:
a second processor; and
a second non-transitory computer-readable medium comprising computer-executable instructions that, when executed by the second processor, causes the second processor to perform the following operations:
receiving, from the target apparatus on the source apparatus not being aware that the first apparatus being detached, and indication of the successful completion of the handover as a result of the first apparatus not receiving the radio resource control connection reconfiguration message from the source apparatus;
receiving, from the target apparatus, an indication that the handover is a single active protocol stack handover and not a condition handover;
initiate data forwarding to the target apparatus;
stop downlink transmissions to and from the first apparatus;
send a sequence number status transfer message to the target apparatus; and
forward user plane data to the target apparatus.

53. The system of claim 52, wherein the first set of computer-executable instructions further cause the first processor to inform the target apparatus about the completion of the handover by:
sending a radio resource control connection reconfiguration complete message comprising an indication of a failure to receive a handover resume message using a periodic uplink grant received from the target apparatus.

54. The system of claim 52, wherein the first set of computer-executable instructions further cause the first processor to inform the target apparatus about the completion of the handover by:
multiplexing an indication of a failure to receive a handover resume message in a medium access control element with a medium access service data unit using a periodic uplink grant received from the target apparatus.

55. The system of claim 54, wherein the periodic uplink grant is received in the random access response.

56. The system of claim 55, wherein the handover is a single active protocol stack handover and not a condition handover based on the first apparatus failing to receive the radio resource control connection reconfiguration message with the predefined duration.

57. The system of claim 56, wherein the second set of computer-executable instructions further cause the second processor to:
send, to the first apparatus, the radio resource control connection reconfiguration message.

58. The system of claim 57, wherein the radio resource control connection reconfiguration message is received by the first apparatus from the source apparatus after the predefined duration.

59. A method, comprising:
performing a random access procedure with a target base station;
receiving, during the random access procedure, a random access response from the target base station;
sending an acknowledgment, by lower layer signaling on a physical uplink control channel, of a successful reception of the random access response to the target base station; and
based on sending the acknowledgement, starting a timer for a predefined duration upon receiving the random access response, the timer being configured by the target base station; and
based on a radio resource control connection reconfiguration message not being received by a user equipment from a source base station within the predefined duration:
detaching the user equipment from the source base station;
flushing data buffers of medium access control, radio link control, and packet data convergence protocol;
update a security key of the packet data convergence protocol; and
completing handover to the target base station without informing the source base station of a successful handover;
informing the target base station about a failure to receive the radio resource control connection reconfiguration message from the source base station and about a completion of completion of the handover; and
initiate user plane communication of packet data between the user equipment and the target base station;
receiving, from the target base station based on the source base station not being aware that the user equipment being detached, and indication of the successful completion of the handover as a result of the user equipment not receiving the radio resource control connection reconfiguration message from the source base station;
receiving, from the target base station, an indication that the handover is a single active protocol stack handover and not a condition handover;
initiating data forwarding to the target base station;
stopping downlink transmissions to and from the user equipment;
sending a sequence number status transfer message to the target base station; and
forwarding user plane data to the target base station.

60. The method of claim 59, further comprising sending a radio resource control connection reconfiguration complete message comprising an indication of a failure to receive a handover resume message using a periodic uplink grant received from the target base station.

61. The method of claim 59, further comprising multiplexing an indication of a failure to receive a handover resume message in a medium access control element with a medium access service data unit using a periodic uplink grant received from the target base station.

62. The method of claim 61, wherein the periodic uplink grant is received in the random access response.

63. The method of claim 62, wherein the handover is a single active protocol stack handover and not a condition handover based on the user equipment failing to receive the radio resource control connection reconfiguration message with the predefined duration.

64. The method of claim 63, further comprising:
sending, to the user equipment, the radio resource control connection reconfiguration message; and
wherein the radio resource control connection reconfiguration message is received by the user equipment from the source base station after the predefined duration.
